(19) United States
(12) Patent Application Publication
(10) Pub. No.: US 2014/0201237 A1
(43) Pub. Date: Jul. 17, 2014

(54) GATHERING SEARCH QUERIES FROM EXTERNAL DEVICES FOR COLLABORATIVE SEARCHING

(71) Applicant: INTERNATIONAL BUSINESS MACHINES CORPORATION, Armonk, NY (US)

(72) Inventors: Barry A. Kritt, Raleigh, NC (US); Sarbajit K. Rakshit, Kolkata (IN)

(73) Assignee: International Business Machines Corporation, Armonk, NY (US)

(21) Appl. No.: 13/741,017

(22) Filed: Jan. 14, 2013

(51) Int. Cl. G06F 17/30

(52) U.S. Cl. CPC G06F 17/30864
USPC 707/770

(57) ABSTRACT

A system for receiving search queries from more than one remote device and performing collaborative searching is provided. The system includes more than one remote mobile device connected to a computer. Each remote mobile device generates search data that includes user data that comprises a user profile and search behavior. The remote devices generate search queries that are simultaneously received by the computer, which also receives the user data. The computer parses the search queries and user data for determining commonalities and then performs a search representative of at least one common search query. The computer then provides the search results to a user, where the search results comprise a listing of results representative of the common search query.

### BACKGROUND

The present invention relates generally to search technologies and, more specifically, to a system for gathering additional search query from external devices for performing collaborative searching.

The Internet continues to grown in importance and is becoming an ever increasing source of information and news. As the Internet is used by more and more people as a source for obtaining information and doing research, search technologies continue to evolve in an effort to provide individual users with the ability to retrieve relevant information that can be digested, understood and synthesized into knowledge. With the Internet continuing to flourish, the number of websites also continues to grow, with over 200,000,000 websites currently on the Internet by some estimates. The extraordinary number of websites available on the Internet has made the ability to find relevant information increasingly difficult.

In a typical search scenario, a user submits a search string to a search engine which analyzes the string and then returns its search results to the user. The user may then choose among the returned results. However, often the search results are not precisely, or sufficiently close, to the expected search results, so they choose to refine their search string, in an effort to narrow, or broaden, or otherwise change the scope of the search. To do this, the user edits the original search string by possibly adding, deleting, or changing search terms in the search string. The edited search string is then again submitted to the search engine, which begins the search process all over again.

This straightforward search process often breaks down when the search is being performed as part of a group decision-making process. In a group situation, typically one person runs the search while others in the group randomly offer their own, and often conflicting, advice on what the search string should be and how to edit the search. Most people have some experience in group decision making, wherein individual group members, each with a different set of constraints and personal preferences, try to work together to make a unified decision that affects everyone in the group. Whether the outcome of the search is of high importance, such as a business or medical decision, or trivial, such as selecting a restaurant in which to dine, the problems of fully considering the input of all group members and fairly resolving any conflicts within the group are typically daunting. When applied to refining a search, the group decision-making dynamics can often lead to frustration when inputs are misunderstood or conflicts are not satisfactorily resolved. Some group members may feel that their concerns were not properly weighted or were not considered at all.

Currently, there are a number of solutions that allegedly provide a variety of methods and systems to facilitate searching. Some of these methods and systems attempt to take advantage of the collective ability of users to create search queries for the purpose of data collection. Generally, these prior art methods and systems do not allow for, or envision, users collaborating in a structured arrangement of search queries. In fact, most known methods and systems rely on subordinate relationships, as well as the creation of taxonomies that are strictly enforced.

Other methods and systems allow users to actively and transparently influence one another through joint search systems, but do not truly enable a working collaboration. These methods and systems contemplate downstream users being influenced by other searches, bringing new search ideas and queries to bear, but not in an active, ongoing and truly collaborative refinement. Thus, these methods and systems describe searching techniques that allow individuals to search and build upon previous searches in a static and potentially hierarchical manner.

### BRIEF SUMMARY

In one general embodiment, a method includes providing a computing device for performing a search, selecting more than one remote mobile device to connect to the computing device, and gathering search data from the selected remote mobile devices. The method then continues determining commonalities in the search data, generating a search query representative of more than one commonality in the search data, and performing a search representative of the search query. The method then ends with providing search results to a user.

In another general embodiment a system that includes more than one remote mobile device. Each remote mobile device comprises a first computer usable medium for running computer usable program code. The computer usable program code is configured to generate search data and to generate user data. The user data includes a user profile and user search behavior. The computer usable program code is also configured to generate a search query. The system further includes a computing device selectively connected to more than one of the remote mobile devices. The computing device comprises a second computer usable medium for running computer usable program code on the computing device. The computer usable program code is configured to receive search queries and perform collaborative searching. The computer usable program code comprises computer usable program code configured to simultaneously receive search queries from the selected remote mobile devices, computer usable program code configured to simultaneously receive user data from the remote mobile devices, the user data including user profiles and user search behaviors, computer usable program code configured to simultaneously parse search queries for determining commonalities in the search queries, and computer usable program code configured to simultaneously parse user data for determining commonalities in the user data. The computer usable program code is configured to perform a search representative of at least one common search query and provide search results to a user. The search results comprising a listing of results representative of the common search query.

In further general embodiment, a computer program product that comprises a computer usable medium having computer usable program code embodied therewith. The computer usable program code comprises computer usable program code configured to receive search queries from more than one remote device and perform collaborative searching. The computer usable program code comprises computer usable program code configured to receive simultaneous search queries from more than one selected remote device, computer usable program code configured to parse the search queries for determining commonalities, and computer usable program code configured to simultaneously receive user data from the remote mobile devices, the user data including user profiles and user search behaviors. The computer usable program code further comprises computer usable program code configured to parse the user data for determining commonalities, and computer usable program code configured to perform a search representative of at least one common search query and at least one commonality in the user data. The computer usable program code then comprises computer usable program code configured to provide search results to a user, the search results comprising a listing of results representative of the common search query and at least one commonality in the user data.

### BRIEF DESCRIPTION OF THE SEVERAL VIEWS OF THE DRAWINGS

FIG. 1 illustrates a simplified diagram of an exemplary embodiment of a system for gathering additional search queries from external devices for performing collaborative searching of the invention;

FIG. 2 illustrates is a simplified block diagram of a computing device in accordance with an embodiment of the invention;

FIG. 3 illustrates is a simplified block diagram of a remote device in accordance with an embodiment of the invention; and

FIG. 4 is a flowchart showing an exemplary process for gathering additional search queries from external devices for performing collaborative searching in accordance with an exemplary embodiment of the invention; and

### DETAILED DESCRIPTION

The following description is made for the purpose of illustrating the general principles of the invention and is not meant to limit the inventive concepts claimed herein. Further, particular features described herein can be used in combination with other described features in each of the various possible combinations and permutations. Unless otherwise specifically defined herein, all terms are to be given their broadest possible interpretation including meanings implied from the specification as well as meanings understood by those skilled in the art and/or as defined in dictionaries, treatises, etc.

In one general embodiment, a method includes providing a computing device for performing a search, selecting more than one remote mobile device to connect to the computing device, and gathering search data from the selected remote mobile devices. The method then continues determining commonalities in the search data, generating a search query representative of more than one commonality in the search data, and performing a search representative of the search query. The method then ends with providing search results to a user.

In another general embodiment a system that includes more than one remote mobile device. Each remote mobile device comprises a first computer usable medium for running computer usable program code. The computer usable program code is configured to generate search data and to generate user data. The user data includes a user profile and user search behavior. The computer usable program code is also configured to generate a search query. The system further includes a computing device selectively connected to more than one of the remote mobile devices. The computing device comprises a second computer usable medium for running computer usable program code on the computing device. The computer usable program code is configured to receive search queries and perform collaborative searching. The computer usable program code comprises computer usable program code configured to simultaneously receive search queries from the selected remote mobile devices, computer usable program code configured to simultaneously receive user data from the remote mobile devices, the user data including user profiles and user search behaviors, computer usable program code configured to simultaneously parse search queries for determining commonalities in the search queries, and computer usable program code configured to simultaneously parse user data for determining commonalities in the user data. The computer usable program code is configured to perform a search representative of at least one common search query and provide search results to a user. The search results comprising a listing of results representative of the common search query.

In further general embodiment, a computer program product that comprises a computer usable medium having computer usable program code embodied therewith. The computer usable program code comprises computer usable program code configured to receive search queries from more than one remote device and perform collaborative searching. The computer usable program code comprises computer usable program code configured to receive simultaneous search queries from more than one selected remote device, computer usable program code configured to parse the search queries for determining commonalities, and computer usable program code configured to simultaneously receive user data from the remote mobile devices, the user data including user profiles and user search behaviors. The computer usable program code further comprises computer usable program code configured to parse the user data for determining commonalities, and computer usable program code configured to perform a search representative of at least one common search query and at least one commonality in the user data. The computer usable program code then comprises computer usable program code configured to provide search results to a user, the search results comprising a listing of results representative of the common search query and at least one commonality in the user data.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. The computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java®, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

For purposes of describing the embodiments disclosed herein, two elements are considered to be coupled when one element is able to send an electrical signal to another element. The electrical signal may represent, for example but not limited to, data, operating commands, status information, or electrical power, or any combination of these electrical signals. A coupling may be implemented by wired or wireless connection means.

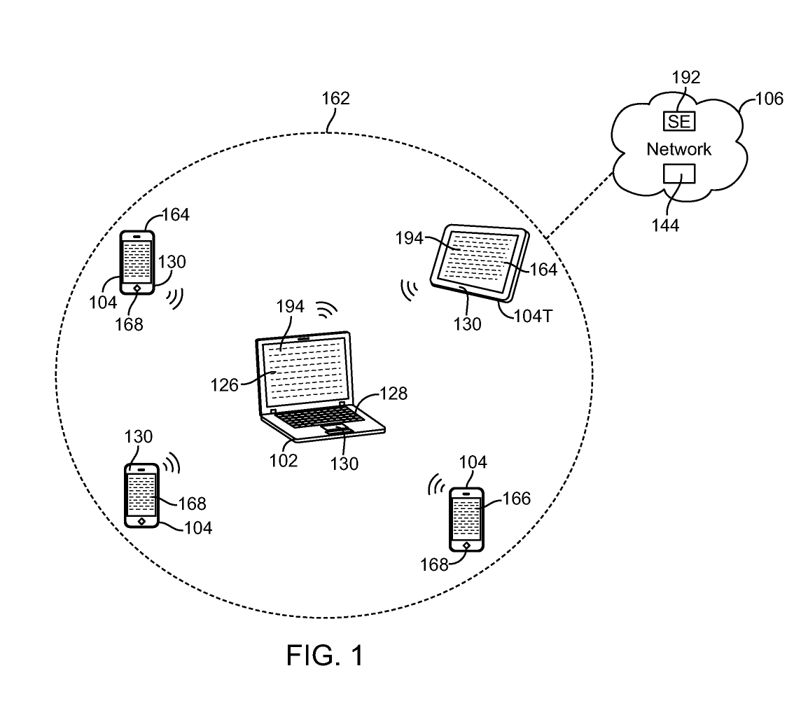

Referring now to FIG. 1 there is shown, generally at 100, an exemplary embodiment of a system for gathering additional search query from external devices for performing collaborative searching. In one embodiment, the system 100 includes a computing device 102 connected to more than one remote mobile device 104 to perform collaborative searching on an external network, such as the Internet 106. In some embodiments the computing device 102 may comprise a known desktop computer, laptop computer, notebook computer, tablet computer, smartphone, or any suitable computing device capable of connecting to a network and running an Internet search engine and performing an Internet search. In one exemplary embodiment, the computing device 102 comprises a portable mobile computer, such as a laptop, notebook, or tablet computer. A laptop computer 102 is shown in the drawings for ease of discussion only.

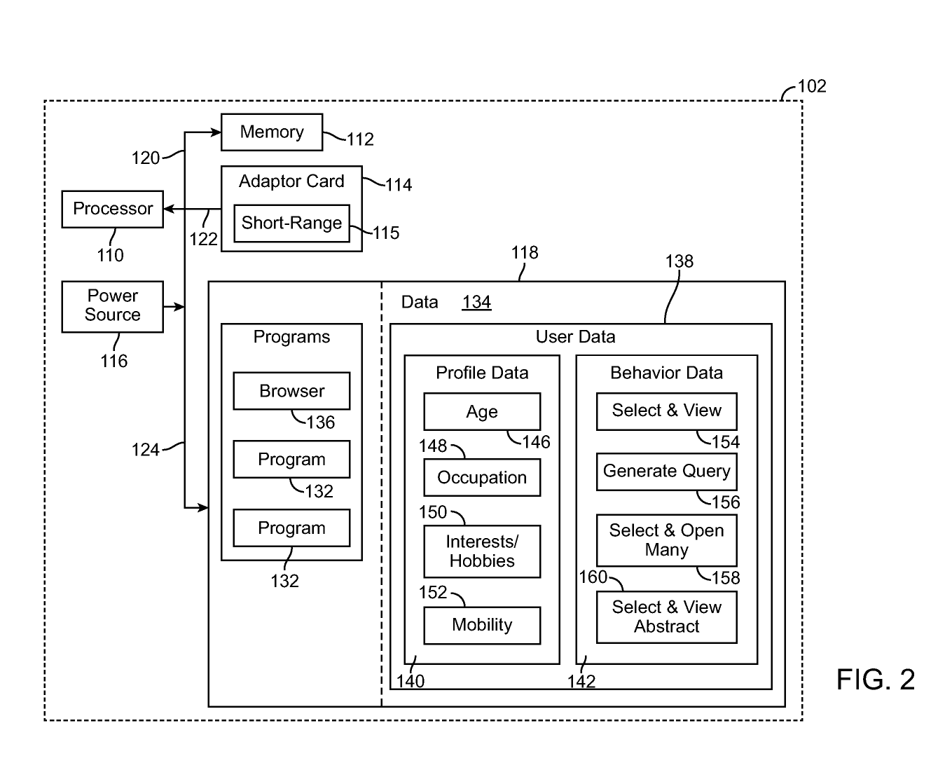

As seen in FIG. 1 and FIG. 2, in a general embodiment, the computer 102 comprises a processor 110 for processing data, a memory 112, an adaptor card 114, an on-board power source 116 such as a battery, and optionally, a nonvolatile storage device 118. In some embodiments, the processor 110 is connected to the memory 112 via memory data and address lines 120, to the adaptor card 114 by a data bus 122, and to the data storage device 118 via data lines 124. The memory 112 may comprise a known volatile memory device for temporary data storage. However, in some embodiments, the memory 112 may comprise both volatile and nonvolatile, providing both temporary and permanent data storage, which may obviate the need for the nonvolatile storage device 118.

The computer 102 may further include a display screen 126 for displaying data, a keyboard 128 for data entry, and a touchpad 130 for moving a pointer (not shown) about the display screen 126. In some optional embodiments, the display screen 126 may comprise a known touchscreen display.

Typically, one or more computer programs and applications 132 and data 134 are stored in the storage device 118. In preferred embodiments, one such computer application 132 stored on the storage device 118 may comprise a web browser application 136. The web browser application, hereinafter web browser 136, is used for searching networks, such as the Internet 106, for desired information. As the user performs one or more searches on the Internet 106 (thoroughly discussed hereinafter), the web browser 136 may request and/or generate user data 138. The user data 138 may include user profile data 140 and user search behavior data 142.

In some embodiments, the user may upload certain profile data 140 to the web browser 136 for access to particular websites 144 on the Internet 106. Alternatively the website 144 may require the user to input their profile data 140 into the web browser 136 prior to granting access to the website 144. Exemplary user profile data may include: the age 146, or an age range, of the user; the user's occupation 148; and personal interests and/or hobbies of the user 150. In an optional embodiment, a website 144 or the web browser 136 may obtain a mobility model 152 of the user. The mobility model 152 may represent the movement of the users and how their location, velocity, and acceleration change over time. It is to be understood that the above-discussed user profile data 140 is for exemplary purposes only and is not an exhaustive list. Many other types of user profile data 140 that may pertain to and/or further define information regarding a user's profile, as described herein, may be realized by persons of ordinary skill in the art.

In a general embodiment, as the user performs one or more searches on the Internet 106, the web browser 136 may generate or collect user search behavior data 142. In an exemplary embodiment, the user search behavior data 142 may include: Select and View 154, Generate Query 156, Select and Open Many 158, and Select and View Abstract 160. In Select and View 136, user behavior data is generated each time the user selects a first search result in the listing of search results and opens an Internet address of the first search result and views information given at the Internet address. For Generate Query 156, data is generated when the users generates at least one additional search query responsive to the listing of search results. In Select and Open Many 158, the data is generated when the user selects and opens a plurality of Internet addresses of search results in the listing of search results and views information given at the Internet addresses for at least a predetermined time period. For View Abstract 160, data is generated each time the user selects and views abstracts of a plurality of search results in the listing of search results. As the user runs the web browser 136 to perform Internet searching, user search behavior data 142 is generated and stored on the storage device 118 to facilitate the ability of web browser 136 to provide relevant search results to the user. It is to be understood that the above-discussed user search behavior data 142 is for exemplary purposes only and is not an exhaustive list. Many other relevant types of user search behavior data 142 that may pertain to and/or further clarify the search behavior of a user, as described herein, may be realized by persons of ordinary skill in the art.

Referring to FIG. 2, the adaptor card 114 is provided for connecting the computer 102 to remote mobile devices 104 and to larger networks, such as the Internet 106. In optional embodiments, the adaptor card 114 may be configured for wired connections. For example, the adaptor card 114 may comprise an adaptor card for connecting the computer 102 to a wired network (not shown), such as a Local Area Network (LAN), via known wiring technologies, such as Ethernet.

In preferred embodiments, the adaptor card 114 may comprise a wireless network interface controller card for connecting the computer 102 wirelessly to the Internet 106. The adaptor card 114 may comprise a known Wi-Fi® transmitter/receiver for data transmission between the Internet 106 or other wireless networks. “Wi-Fi” is a trademark of Wi-Fi Alliance, Austin, Tex. In such an embodiment, the adaptor card 114 communicates with the Internet 106 wirelessly using radio frequency signals.

Additionally, the adaptor card 114 may be capable of short-range wireless data transmission for connection to a Wireless Personal Area Network (WPAN) 162. In one embodiment, the adaptor card 114 is configured with a short-range component 115 to facilitate connection to the WPAN 162. The WPAN 162 is a computer network used for communication among computerized devices, including desktop computers, laptop computers, tablet computers, and smartphones. The WPAN 162 can be used for communication among these devices themselves, known in the art as “intrapersonal communication”, or for connecting to a higher level network and to the Internet 106. The reach of the WPAN 162 varies from a few centimeters, to about 10 meters over wireless network technologies such as, Bluetooth®. “Bluetooth” is a trademark of Bluetooth SIG, Kirkland, Wash. Bluetooth® is a short-range wireless technology that facilitates interconnectivity between computers, laptop computers 102, mobile phones, smartphones, tablets, and many other handheld mobile computing devices. Bluetooth® technology affords Bluetooth®-enabled devices to interconnect wirelessly within an approximate 10 meter range. Thus, the adaptor card 114 may comprise any known, suitable wireless signal transmitting and receiving device capable of connecting to the Internet 106 and to a WPAN 162, in exemplary embodiments of the invention.

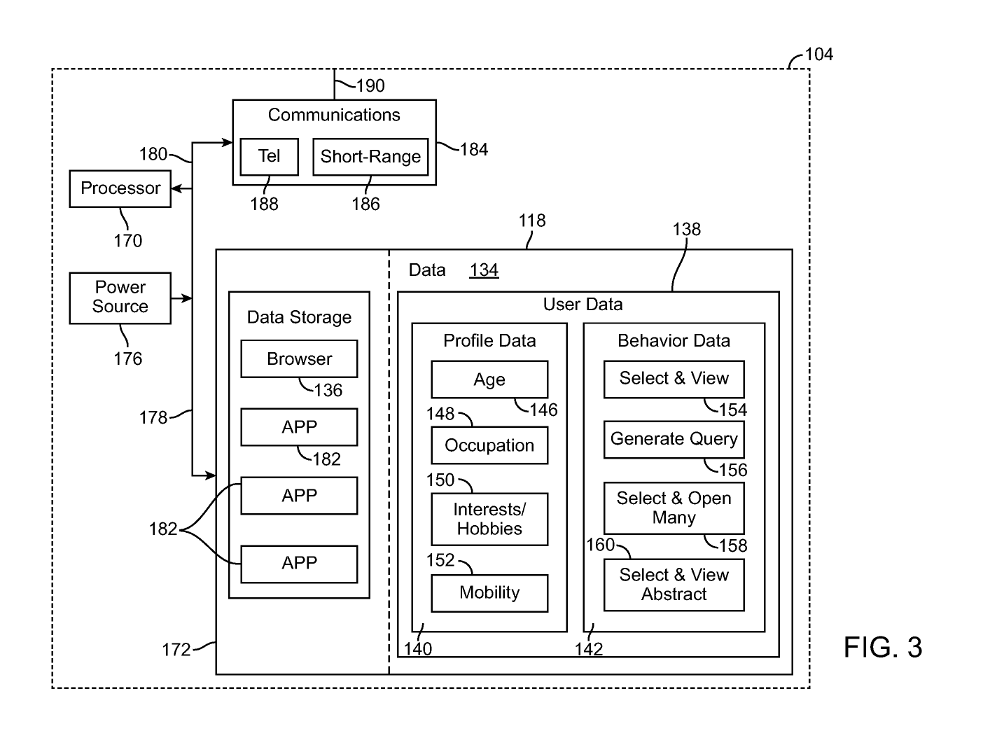

As illustrated in FIG. 1 and FIG. 3, in some embodiments of the invention, each of the more than one remote mobile devices 104 comprises a mobile device with advanced computing and connectivity capabilities. In exemplary embodiments, the remote mobile devices 104 may comprise known mobile devices with advanced computing and connectivity capabilities that include: smartphones, tablets (tablet computers), laptop computers, and personal digital assistants (PDAs), among many other known types of mobile devices having advanced computing and connectivity capabilities. For ease of discussion only, a tablet 104T and smartphones 104 are shown in the Figures.

An exemplary remote mobile device 104, such as a smartphone 104 or tablet 104T, may comprise a housing 164 that retains touchscreen 166. The touchscreen 166 is provided to allow a user to input, manipulate, and view data. In other known embodiments, the remote mobile device 104 may be configured with both a touchscreen 166 and keyboard (not shown). In such an embodiment, the user my input and manipulate data using both the keyboard and touch screen 166, as known in the art. Additionally, each remote mobile device 104 may include a home button 168 that is also retained in the housing 164. The home button 168 is provided for displaying a home menu (not shown) on the touchscreen 166, and may provide additional functionalities for the remote mobile device 104.

As illustrated in FIG. 3, in general embodiments, each remote mobile device 104 includes processor 170 for processing data, a memory 172, a communications module 174, and an on-board power source 176, such as a battery. In some embodiments, the processor 170 is connected to the memory 172 via memory data and address lines 178 and to the communications module 174 by a data bus 180. The memory 172 may comprise both volatile and nonvolatile data storage, as is known.

In some embodiments, data 134 and application software 182 may be stored in the memory 172. Application software 182, each of which is known in the art as an “app”, comprises software which is specifically written for mobile devices and is designed to perform specific tasks. The “app” abbreviation represents both the smaller program size and smaller scope of the application software 182. Examples of apps 182 include media players and apps whose sole purpose is to display an image representation of the current weather. One or more apps 182 may be provided with the mobile device 104 or may be purchased separately by a user.

In preferred embodiments, one such app 182 stored in memory 172 may comprise a web browser application 136, analogous to the web browser 136 running on the computer 102. The web browser app, hereinafter web browser 136, is used for searching networks, such as the Internet 106, as discussed above. As the user performs one or more searches on the Internet 106, the web browser 136 may request and/or generate user data 138. The user data 138 may include user profile data 140 and user search behavior data 142.

For example, the user may upload profile data to the web browser 136 for access to websites 126 or the website may require the user to input their profile data into the web browser 136, as discussed previously. Exemplary user profile data may include: the age 146; occupation 148; personal interests and/or hobbies 150, and optionally mobility model 152 of the user. It is to be understood that the above-discussed user profile data 140 is for exemplary purposes only and is not an exhaustive list. Many other types of user profile data 140 that may pertain to and/or further define information regarding a user's profile, as described herein, may be realized by persons of ordinary skill in the art.

Similarly, as the user performs one or more searches on the Internet 106 using the remote mobile device 104, the web browser 136 may generate or collect user search behavior data 142. Exemplary user search behavior data 142 may include: Select and View 154, Generate Query 156, Select and Open Many 158, and Select and View Abstract 160, as discussed previously. It is to be understood that the above-discussed user search behavior data 142 is for exemplary purposes only and is not an exhaustive list. Many other relevant types of user search behavior data 142 that may pertain to and/or further clarify the search behavior of a user, as described herein, may be realized by persons of ordinary skill in the art.

Each remote mobile device 104 may also include a communications module 184 for data transmission and voice communications. The communications module 184 may comprise a component of the processor 170 or may comprise stand-alone circuitry, as shown in FIG. 3. The communications module 184 is capable of wirelessly connecting the remote mobile device 104 to external networks, such as the Internet 106 and to short-range intrapersonal networks, such as a WPAN 162. For example, the communications module 184 may comprise a known Wi-Fi® transmitter and receiver that provides high-speed data transmission between the remote mobile device 104 and Internet 106. Preferably, the communications module 184 provides data transmission rates sufficient to allow a user to browse websites and other data on the Internet 106.

In some preferred embodiments, the communications module 184 may be configured with a short-range component 186 to facilitate connection to the WPAN 162. The short-range component 186 provides short-range wireless data transmission using known technologies, such as, Bluetooth®. The short-range wireless capability of the communications module 184 affords interconnection of the other remote mobile devices 104, 104T and laptop computer 102, as well as other devices having short-range wireless data transmission capabilities, may be wirelessly interconnected via the WPAN 162, as discussed previously.

Known telecommunications circuitry 188 may be provided in smartphone embodiments of the remote mobile device 104, for providing telecommunications functionality. In some embodiments, the telecommunications circuitry 188 may be coupled to the processor 170 and/or to the communications module 184, allowing the processor 170 to control the functions of the telecommunications circuitry 188, as is known in the art. Alternatively, the telecommunications circuitry 188 may be directly controlled by a user actuating the telecommunications circuitry 188 via the touchscreen 166. Often, the telecommunications circuitry 188 is controlled by both the processor 170 and by a user (not shown) of the remote mobile device 104.

An antenna 190 to facilitate transmission of radio frequency signals may be coupled to the telecommunications circuitry 188 and to the communications module 184. The antenna 190 is provided to facilitate transmission of radio frequency signals for both data and telecommunications transmissions.

A user desires to search the Internet 106 for information. For example, the user may be searching for local weather conditions, restaurants offering a particular cuisine, or nightlife in a neighboring town. To perform the search, the user invokes a web browser 136 on their computing device. As disused herein, the user's computing device may comprise a laptop computer 102, or any of the discussed remote mobile devices such as smartphones 104, tablet 104T, or other known computing devices with advanced computing and connectivity capabilities. The user inputs a string of characters, which comprises a search query, to the web browser 136. The web browser 136 accesses a web search engine 192 running on the Internet 106. The search engine 192 analyzes the string and then returns its search results to the user in the form of a search engine results Page (SERP) 194 that is displayed on the screen of their remote mobile device 104, 104T or computer 102, which my comprise either a display screen 126 or touchscreen 166. The user may then choose among the search results returned on the SERP 194 or if the search results are not precisely, or sufficiently close, to the expected search results, the user may edit their search string. The user inputs the edited search string and the search engine 192 analyzes the edited search string and then returns its search results to the user in the form of the SERP 194.

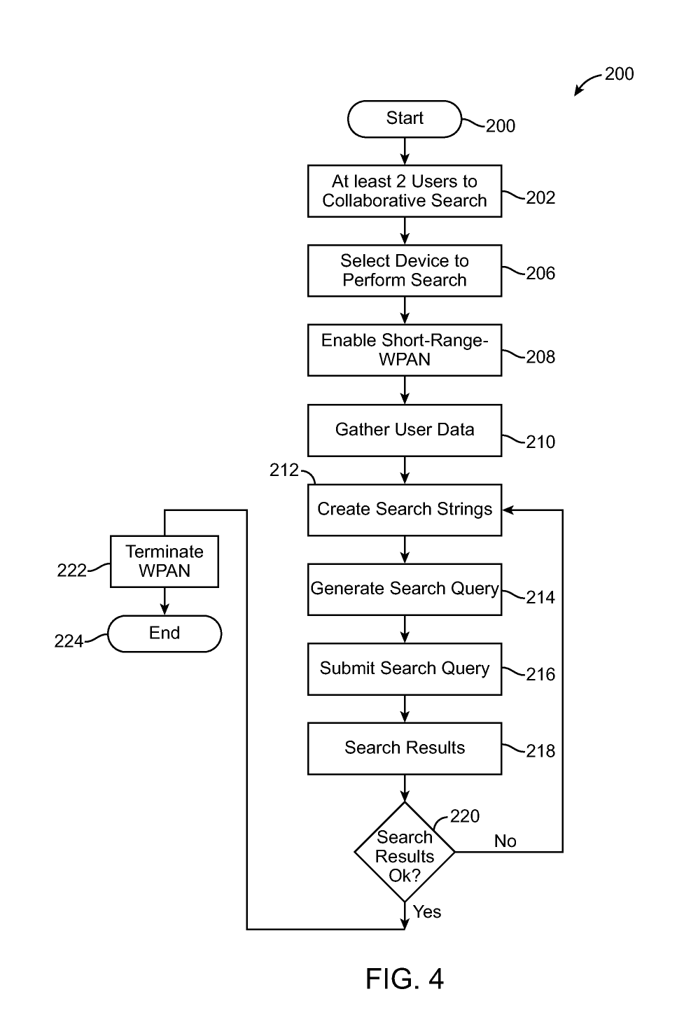

Referring to the Figures, and particularly to FIG. 4, a flowchart of an exemplary embodiment of a process for gathering additional search queries from external devices for performing collaborative searching in accordance with the invention, is shown generally at 200. The process 200 starts with start block 202. In process block 204, at least two users desire to search the Internet 106 for related information, and thus perform a collaborative search. For example, the users of the remote mobile devices 104, 104T and computer 102 desire to collaboratively search the Internet 106 for restaurants offering a particular cuisine. For ease of discussion only, it is assumed that a user is associated with each smartphone 104, the tablet 104T, and laptop computer 102.

In process block 206 it is decided as to which computing device will perform the search. Selection of the computing device, including smartphones 104, tablet 104T, and laptop computer 102 is purely arbitrary. The device selected to perform the search may be any one of the laptop computer 102, smartphones 104, or tablet 104T. For sake of clarity only, the laptop computer 102 is selected to perform the search.

The process 200 then continues to process block 208, where the short-range wireless capability of the communications module 184 of the smartphones and tablet 104T, as well as the adaptor card 114 of the laptop computer 102, are each activated to interconnect of the remote mobile devices 104, 104T and laptop computer 102 in the form of the WPAN 162.

In process block 210 user data 138 is gathered from two or more of the remote mobile devices 104, 104T. In optional embodiments, the user data 138 may not be gathered from the device performing the search, such as the computer 102. The user data 138 gathered may comprise all, or any portion, of the user profile data 140 and/or user search behavior data 142 previously discussed. In some general embodiments, the user data 138 is gathered from each remote mobile device 104, 104T. In optional embodiments, the user data 138 is gathered from selected remote mobile devices 104, 104T, which may include the computer 102. The user data 138 gathered for performing the search is relevant to the search, in preferred embodiments. If the search to be performed relates to activities, personal interests and/or hobbies 150 of the user profile data 140 may be used. For example, if the user profile data 140 of the users of the remote mobile devices 104, 104T and computer 102 indicates that the users are young adult males, the search results may be tailored to those individuals, as opposed to search results that may be provided to a group of middle aged females.

Similarly, related and/or relevant user search behavior data 142 from each remote mobile device 104, 104T may also be used to perform the search. The desired user data 138 is then transmitted to the computer 102, or optionally, the computer 102 may access each remote mobile device 104, 104T to obtain the desired user data 138, via the WPAN 162.

The process 200 then continues to process block 212, where each user creates their own search string and submits the search string to the computer 102 performing the search. For example, a first user may submit the search string “Italian restaurant”, while a second user submits the search string “Italian food”, a third user submits the search string “authentic Tuscan food”, and a forth user submits the search string “ Italy theme restaurants.”

In process block 214, the gathered user data 138 and search strings received from each user of the remote mobile devices 104, 104T and computer 102 is processed to generate a search query. The user data 138 and search strings are parsed for determining commonalities. In the given example, a determined commonality in the search strings received from the remote mobile devices 104, 104T may be “Italian”, while another commonality may be “restaurant.” Additionally, user data 138, such as user search behavior data 142 and user profile data 140, may be parsed for determining commonalities. For example, the users may have common mobility models 152, which may indicate a location for a restaurant common to all users. The users, all may live in New York City, N.Y., for example. Other user search behavior data 142 and user profile data 140 may be parsed for determining additional commonalities. For example, the search query “Italian restaurant New York City” may be generated in process block 214.

The generated search query is then submitted to a search engine 192 via the web browser 136, in process block 216. The search engine 192 analyzes the string and then returns its search results to the users in the form of a search engine results Page (SERP) 194, in process block 218. The SERP 194 may comprise a listing of websites 144 of Italian restaurants located in New York City, N.Y.. The SERP 194 may be displayed on the computer's display screen 126. Optionally, the SERP 194 may be display on the touchscreens 166 of the remote mobile devices 104, 104T in addition to the computer's display screen 126.

In decision block 220, the users determine if the search results returned in the SERP 194 are sufficient. If the results returned in the SERP 194 meet the expectations of the users, then the process 200 continues to process block 224. If the results returned in the SERP 194 do not meet the expectations of the users, the process 200 retunes to process block 212, where each user may then generate an edited search string, and the process 200 is repeated from that point forward. Otherwise, in process block 222 one or more users may disconnect from the WPAN 162, thus ending their participation in collaborate searching. Alternatively, additional remote mobile devices 104, 104T may be added to the WPAN 162, as discussed above, and they process 200 repeated for performing additional collaborative searches. Further, one or more users disconnect their remote mobile devices 104, 104T from the WPAN 162, the remaining users may perform additional collaborative searches, so long as there are at least two users and subsequently at least two devices, such as the computer 102 and at least one remote mobile devices 104 to participate in collaborate searching. The process 200 then ends at end block 224.

Those skilled in the art will appreciate that various adaptations and modifications can be configured without departing from the scope and spirit of the embodiments described herein. Therefore, it is to be understood that, within the scope of the appended claims, the embodiments of the invention may be practiced other than as specifically described herein.

What is claimed is:

1. A method comprising:
providing a computing device for performing a search;
selecting more than one remote mobile device to connect to the computing device;
gathering search data from the selected remote mobile devices;
determining commonalities in the search data;
generating a search query representative of more than one commonality in the search data;
performing a search representative of the search query; and
providing search results to a user.

2. The method of claim 1, wherein the computing device simultaneously gathers the search data from each remote mobile device.

3. The method of claim 2, wherein the search data comprises a search query and user data.

4. The method of claim 3, wherein the user data comprises user profile information and user search behavior.

5. The method of claim 4, further comprising:
user profile information comprising at least one of an age range, occupation, and interests of a user associated with a remote mobile device; and
user search behavior comprising at least one of selecting a first search result in the listing of search results and opening an Internet address of the first search result and viewing information given at the Internet address, and generating at least one additional search query responsive to the listing of search results.

6. A system comprising:
more than one remote mobile device, each remote mobile device comprising:
a first computer usable medium for running computer usable program code, the computer usable program code configured to generate search data, the computer usable program code comprising:
computer usable program code configured to generate user data, the user data including a user profile and user search behavior; and
computer usable program code configured to generate a search query; and
a computing device selectively connected to more than one of the remote mobile devices, the computing device comprising:
a second computer usable medium for running computer usable program code on the computing device, the computer usable program code configured to receive search queries and perform collaborative searching, the computer usable program code comprising:
computer usable program code configured to simultaneously receive search queries from the selected remote mobile devices;
computer usable program code configured to simultaneously receive user data from the remote mobile devices, the user data including user profiles and user search behaviors;
computer usable program code configured to simultaneously parse search queries for determining commonalities in the search queries;
computer usable program code configured to simultaneously parse user data for determining commonalities in the user data;
computer usable program code configured to perform a search representative of at least one common search query; and
computer usable program code configured to provide search results to a user, the search results comprising a listing of results representative of the common search query.

7. The system of claim 6, wherein the user profile data comprises at least one of an age range, occupation, mobility model, and interests of a user associated with a remote mobile device.

8. The system of claim 7, wherein the user search behavior comprises at least one of:
selecting a first search result in the listing of search results and opening an Internet address of the first search result and viewing information given at the Internet address;
generating at least one additional search query responsive to the listing of search results;
selecting and opening an Internet address of a plurality of search results in the listing of search results and viewing information given at the Internet address for at least a predetermined time period; and
selecting and viewing an abstract of more than one search result in the listing of search results.

9. The system of claim 6, wherein the remote mobile devices are selectively coupled to the computing device via a wireless personal area network.

10. The system of claim 6, wherein the remote mobile devices are selectively coupled to the computing device via a wireless local area network.

11. The system of claim 6, wherein the remote mobile devices comprise one of a smartphone and tablet computing device.

12. The system of claim 6, wherein the search results to provided to the user comprise a search engine results page, the search engine results page comprising a listing of results returned by a search engine in response to the search query in more than one search category.

13. The system of claim 11, wherein the user selects at least one search category of the search results.

14. The system of claim 8, further comprising:
computer usable program code configured to perform a search representative of at least one common search query and at least one commonality in the user profile data and user search behavior.

15. A computer program product comprising:
a computer usable medium having computer usable program code embodied therewith, the computer usable program code comprising:
computer usable program code configured to receive search queries from more than one remote device and perform collaborative searching, the computer usable program code comprising:
computer usable program code configured to receive simultaneous search queries from more than one selected remote device;
computer usable program code configured to parse the search queries for determining commonalities;
computer usable program code configured to simultaneously receive user data from the remote mobile devices, the user data including user profiles and user search behaviors;
computer usable program code configured to parse the user data for determining commonalities;
computer usable program code configured to perform a search representative of at least one common search query and at least one commonality in the user data; and
computer usable program code configured to provide search results to a user, the search results comprising a listing of results representative of the common search query and at least one commonality in the user data.

16. The computer program product of claim 15, further comprising:
the user data including user profile data and user search behavior;
the user profile data comprising at least one of an age range, occupation, mobility model and interests of a user associated with a remote device; and
the user search behavior comprising a user performing at least one of:
selecting a first search result in the listing of search results and open an Internet address of the first search result and viewing information given at the Internet address;
generating at least one additional search query responsive to the listing of search results;
selecting and opening an Internet address of a plurality of search results in the listing of search results viewing information given at the Internet address for at least a predetermined time period; selecting and opening an Internet address of a plurality of search results in the listing of search results viewing information given at the Internet address for at least a predetermined time period; and
selecting and viewing abstracts of a plurality of search results in the listing of search results.

17. The computer program product of claim 15, wherein the search results to provided to the user comprise a search engine results page, the search engine results page comprising a listing of results returned by a search engine in response to the search query in more than one search category.

18. The computer program product of claim 17, further comprising:
computer usable program code configured to provide search query suggestions if the search results comprise a plurality of search categories.

19. The computer program product of claim 18, further comprising:
computer usable program code configured to rank search results by category.

20. The computer program product of claim 19, further comprising:
computer usable program code configured to rank categories of the search results by at least one of commonality in the user data least and one common search query.
